(19) United States
(12) Patent Application Publication
(10) Pub. No.: US 2026/0097436 A1
(43) Pub. Date: Apr. 9, 2026

(54) Drilling Jig for a Profile Sealing Strand, Application Head, System for Applying a Profile Sealing Strand to a Door or Body of a Motor Vehicle, and Method for Creating a Bore

(71) Applicant: ATN Hölzel GmbH, Oppach (DE)

(72) Inventors: Immo Geppert, Oppach (DE); Sven Kissal, Oppach (DE); Yannis Artemi Berger, Oppach (DE); Ralph Schäfer, Oppach (DE)

(21) Appl. No.: 19/112,966

(22) PCT Filed: Sep. 20, 2023
(86) PCT No.: PCT/DE2023/100702

§ 371 Date: Mar. 19, 2025

(30) Foreign Application Priority Data
Sep. 21, 2022 (DE) 10 2022 124 317.6

(51) Int. Cl. B23B 47/28; B23B 35/00

(52) U.S. Cl. CPC B23B 47/287; B23B 35/00

(57) ABSTRACT

The objective of the invention is to create a drilling jig for a profile sealing strand, as well as a method for producing a hole, an application head of a profile sealing strand application device, and a system for applying a profile sealing strand, each incorporating the drilling jig according to the invention as a subassembly, which enables the production of holes in the profile sealing strand directly, as needed, and without significant delay in the application process.

Drilling jig for a profile sealing strand,
characterized in
a drilling unit is provided and that at least one guiding device is provided, through which the profile sealing strand can be guided in its longitudinal extension, wherein the guiding device is rotatable with the profile sealing strand relative to the drilling unit around a longitudinal axis of the longitudinal extension of the profile sealing strand, and that the guiding device comprises a rotational angle positioning device.

### CROSS REFERENCE TO RELATED APPLICATIONS

This application is the U.S. national stage of International Application No. PCT/DE2023/100702, filed on 2023-09-20. The international application claims the priority of DE 102022124317.6 filed on 2022-09-21; all applications are incorporated by reference herein in their entirety.

### BACKGROUND

The invention relates to a drilling jig for a profile sealing strand and a method for creating a bore. Furthermore, the invention relates to an application head of a profile seal application device equipped with the inventive drilling jig, and a system for applying a profile sealing strand that includes the drilling jig.

Drilling stations for seal profiles are already known, where the seal is already positioned on the respective component, requiring the component with the seal to undergo an additional processing step. In these cases, either the boreholes in the seal are created at the stationary component by moving the drilling station, or the component with the seal is guided to a stationary drilling station for each borehole to be created, and the boreholes are made accordingly.

Alternatively, the openings can also be created by punching, where the openings are made in the profile sealing strand using a separate punching device before the application of the profile sealing strand. This involves numerous handling steps.

Additionally, DE 10 2016 114 461 A1 discloses a method for creating vent openings in a seal profile, where the vent openings are introduced into the seal profile using a laser beam.

All these solutions share the commonality that they are independent of the application process of the respective profile sealing strand, require additional handling steps, and also take up additional processing time.

### SUMMARY

### Drilling Jig for a Profile Sealing Strand, Application Head, System for Applying a Profile Sealing Strand to a Door or Body of a Motor Vehicle, and Method for Creating a Bore

The objective of the invention is to create a drilling jig for a profile sealing strand, as well as a method for producing a hole, an application head of a profile sealing strand application device, and a system for applying a profile sealing strand, each incorporating the drilling jig according to the invention as a subassembly, which enables the production of holes in the profile sealing strand directly, as needed, and without significant delay in the application process.

Drilling jig for a profile sealing strand,
characterized in
a drilling unit is provided and that at least one guiding device is provided, through which the profile sealing strand can be guided in its longitudinal extension, wherein the guiding device is rotatable with the profile sealing strand relative to the drilling unit around a longitudinal axis of the longitudinal extension of the profile sealing strand, and that the guiding device comprises a rotational angle positioning device.

### DETAILED DESCRIPTION

The objective of the invention is to create a drilling jig for a profile sealing strand, a method for creating a bore, an application head of a profile seal application device, and a system for applying a profile sealing strand, each equipped with the inventive drilling jig as a subassembly. This enables the creation of boreholes in the profile sealing strand directly, as needed, and without significant delays in the application process.

With the invention, it is achieved in the specified application case that a drilling jig for a profile sealing strand is created, where a drilling unit is provided, and at least one guiding device is provided through which the profile sealing strand can be guided along its longitudinal extension. The guiding device, along with the profile sealing strand guided within or by it, is rotatable relative to the drilling unit about a longitudinal axis of the profile sealing strand's extension, and the guiding device includes a rotational angle positioning device. This allows boreholes to be made directly at different points on the profile sealing strand, as the profile sealing strand can be rotated within the guiding device by the rotational angle positioning device itself. Thus, both boreholes without rotation and boreholes with rotation are equally feasible. Additionally, the profile sealing strand can be rotated longitudinally about its axis to the left or right as needed, enabling access to a wide range of the profile sealing strand.

By allowing the profile sealing strand to be guided along its longitudinal extension through the guiding device, the profile sealing strand can initially be freely moved or advanced along its length, for example, for application. When a borehole is needed, the movement or advancement of the profile sealing strand along its length can stop, and the profile sealing strand remains stationary, making it immobile along its length. The borehole can then be created without rotation or with rotation about the longitudinal axis using the rotational angle positioning device. Afterward, the profile sealing strand is returned to its original position for movement or advancement for application using the rotational angle positioning device.

Another aspect of the invention relates to an application head of a profile seal application device, where the application head includes the inventive drilling jig.

A third aspect of the invention relates to a system for applying a profile sealing strand
to a door or body of a motor vehicle, where the system includes the inventive drilling jig and a profile sealing application device with an application head for applying the profile sealing strand to the door or body.

A fourth aspect of the invention relates to a method for creating a bore in a profile sealing strand using the inventive drilling jig, where
the profile sealing strand, moved or stationary along its longitudinal extension, is rotated from an initial position about a longitudinal axis of its extension between 0 degrees and 75 degrees as needed into a drilling position. Subsequently, a drilling unit creates a bore in the profile sealing strand in the drilling position, after which the profile sealing strand is rotated back from the drilling position to the initial position as needed. When the profile sealing strand is rotated about the longitudinal axis of its extension by or around 0 degrees, the initial position and the drilling position are the same.

As needed, the profile sealing strand can be rotated from an initial position about a longitudinal axis of its extension between 76 degrees and 100 degrees into a drilling position.

Advantageous embodiments of the different aspects of the invention are presented in the dependent claims.

By including at least one guiding unit in the guiding device, the profile sealing strand can be guided more reliably, without tension, and with minimal deformation. When two or more guiding units are used, they are spaced apart, ensuring reliable, tension-free, and minimally deformed guidance of the profile sealing strand between the guiding units.

By positioning the rotational angle positioning device in the area of at least one guiding unit or, in the case of two or more guiding units, between two of the guiding units or outside or away from the guiding units, the profile sealing strand can be rotated more reliably, without tension, and with minimal deformation into the respective rotational angle position. Additionally, the construction is simplified.

By equipping the rotational angle positioning device with a guiding unit, the construction is simplified, and the profile sealing strand can be rotated more reliably, without tension, and with minimal deformation into the respective rotational angle position.

By including a roller guide, contour guide, or support guide in the guiding unit, the profile sealing strand can be rotated more reliably, without tension, and with minimal deformation into the respective rotational angle position.

It is also provided that at least two of the mentioned guides, such as the roller guide, contour guide, and/or support guide, can be combined.

By equipping the rotational angle positioning device with friction wheels, a crank mechanism, a worm gear, or a gear drive, flexible and rapid rotational angle adjustment is facilitated.

By driving the rotational angle positioning device using a worm gear as a linear drive or a worm gear drive with a worm and worm wheel, such as a spur gear, or using a servomotor, reliable and flexible rotational angle adjustment is facilitated. Additionally, backlash in rotational angle positioning can be minimized, and good repeatability can be achieved with a worm gear or worm gear drive. A servomotor is reliable and includes a holding brake or high holding torque for position security. Furthermore, it is considered that the rotational angle positioning device can be driven flexibly and quickly using a pneumatic cylinder or a stepper motor. Combinations of at least two of the mentioned drives are also considered.

By positioning the drilling unit in the area of the guiding device, the at least one guiding unit, or, in the case of two or more guiding units, between two of the guiding units or in the area of the rotational angle positioning device, the borehole can be created more reliably and accurately, as the profile sealing strand is rotated more reliably, without tension, and with minimal deformation into the respective rotational angle position in this area, allowing the borehole to be created at the required position and angle.

The drilling unit can also be positioned in the area of the guiding device between one of the guiding units and the rotational angle positioning device.

By arranging the drilling unit with a main working direction transverse or perpendicular to the longitudinal extension of the profile sealing strand, the borehole can be created more easily and accurately at the required position and angle.

By equipping the drilling unit with a pneumatic, electric, or electromechanical linear drive as a tool feed, the borehole can be created quickly, precisely, and controllably.

By providing suction, a blower, or a collection tray, chips or other residues from drilling into the profile sealing strand can be reliably collected and disposed of, preventing disruptive residues and contamination in the system area.

By positioning the drilling jig in the area of the profile sealing strand feed and/or before or after a length measurement of the profile sealing strand on the application head, a space-saving construction is achieved. Additionally, the profile sealing strand can be rotated reliably and without tension in this area to the respective rotational angle position, with minimal impact on the application process.

By positioning the drilling jig in the area of the profile sealing strand feed to the profile sealing application device and/or before or after a length measurement of the profile sealing strand in the system for applying a profile sealing strand to a door or body of a motor vehicle, an optimized construction and reliable, tension-free rotational angle positioning of the profile sealing strand are facilitated.

By making the drilling jig movable or traversable along a feed direction parallel to the profile sealing strand feed on the application head and/or in the system for applying a profile sealing strand, the borehole can be created simultaneously during the application process. Thus, the application process of the profile sealing strand can only be minimally delayed.

The drilling jig according to the invention, or the application head of a profile sealing strand application device with the drilling jig, or the system according to the invention for applying a profile sealing strand with a drilling jig according to the invention and a profile sealing strand application device with an application head according to the invention for applying the profile sealing strand, or the method according to the invention for producing a hole in a profile sealing strand using a drilling jig according to the invention, can each be used or implemented in systems for stationary application and/or mobile application, for example, on a robot with at least one arm section arranged on the robot or on another handling device.

### BRIEF DESCRIPTION OF THE DRAWINGS

Several examples of the invention are shown in the drawings and are described in more detail below. The following is shown:

FIG. 1: A detailed view of a drilling jig,

FIG. 2: A drilling jig on an application head as a detailed view,

FIG. 3: An application head with a drilling jig,

FIGS. 4a and 4b: Detailed views of a drilling unit in different perspectives,

FIGS. 5a to 5c: Detailed views of a drilling jig and rotational angle positioning device in different perspectives, and

FIGS. 6 and 7: Detailed views of the rotational angle positioning device of a guiding device in different perspectives.

### DETAILED DESCRIPTION OF THE PREFERRED EMBODIMENTS

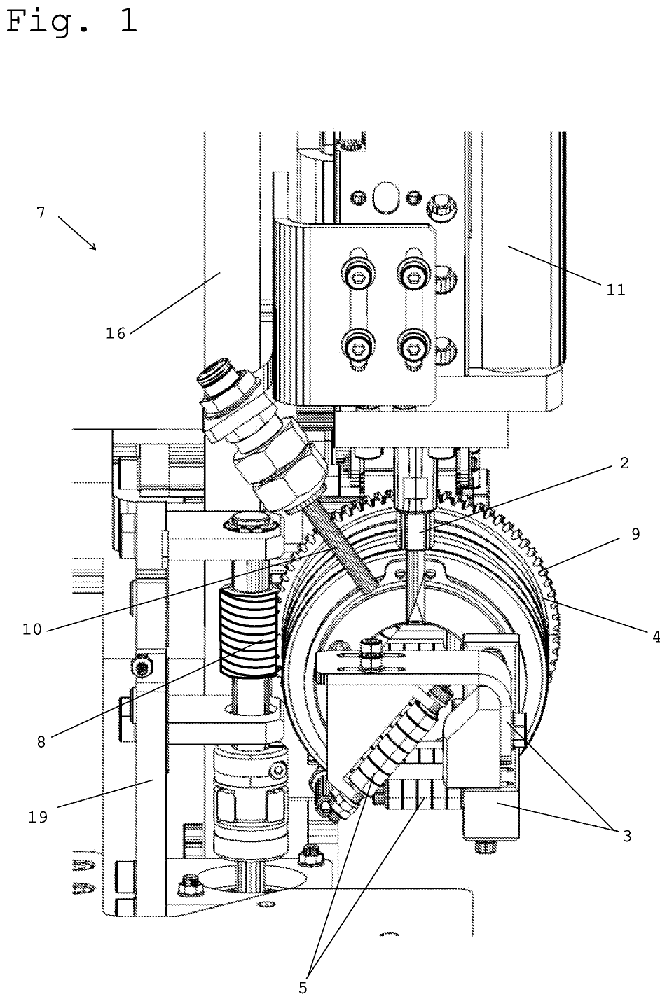

A drilling jig 7 according to the invention for a profile sealing strand 1 (not shown) is illustrated in FIG. 1. Here, a drilling unit 2 and at least one guiding device 3 are provided. The profile sealing strand 1 can be guided in its longitudinal extension by the guiding device 3. The guiding device 3 is rotatable relative to the drilling unit 2 around the longitudinal axis of the profile sealing strand 1. Accordingly, the guiding device 3 includes a rotational angle positioning device 4, with which the guided profile sealing strand can be rotated according to the requirements of the position of the hole to be produced.

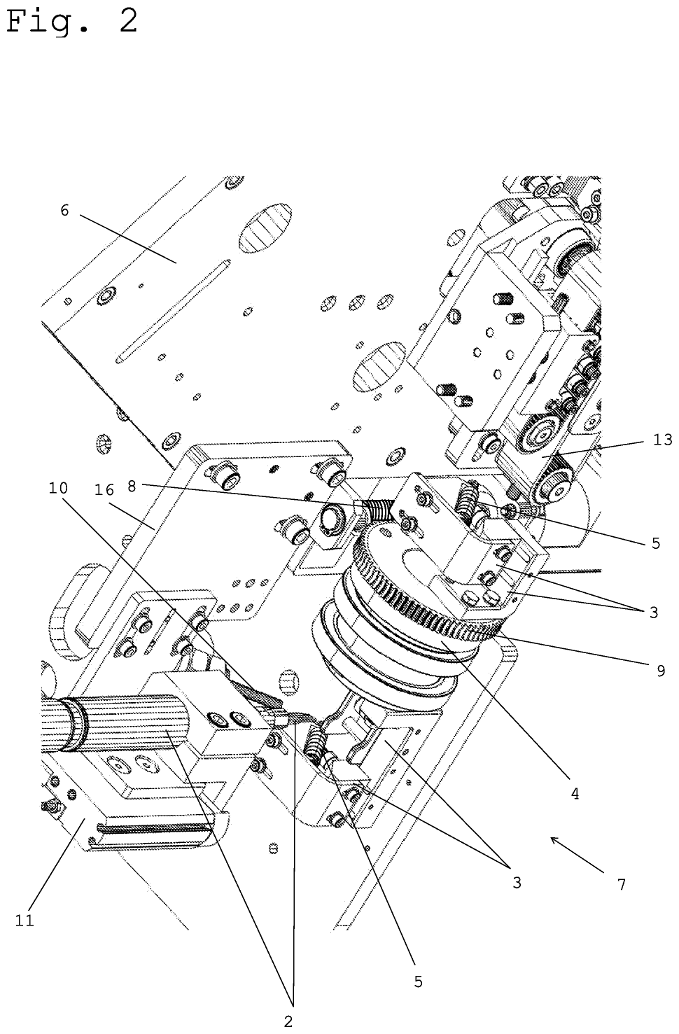

The guiding device 3 comprises at least one guiding unit 5. In the case of two or more guiding units 5, the guiding units 5 are arranged at a distance from each other, for example, on both sides of the rotational angle positioning device 4 in the conveying direction 14 of the profile sealing strand 1. Accordingly, the rotational angle positioning device 4, as shown in FIGS. 2, 3, and 7, is arranged in the area between two of the guiding units 5. The at least one guiding unit 5 or the guiding units 5 can also be arranged differently in the conveying direction 14 of the profile sealing strand 1, so that the rotational angle positioning device 4 is located outside or away from the guiding units 5.

If necessary, the rotational angle positioning device 4 can include a guiding unit 5.

As shown in FIGS. 1, 2, 5a to 5c, and 7, the guiding unit 5 has a roller guide. The roller guide is also arranged as a contour guide with a 45 degree roller guide, as shown in FIGS. 1, 2, and 5a, or as a support guide, as shown in FIGS. 1, 5a, and 7.

The rotational angle positioning device 4 is driven by a worm gear drive with a worm 8 driven by a servomotor and a worm wheel 9 driven by the worm 8. Alternatively, a stepper motor or a servomotor can also be used directly. Similarly, the drive can also be formed from a combination of different drives.

Furthermore, the drilling unit 2 is arranged in the area of the guiding device 3 between the two guiding units 5 and in the area between one of the guiding units 5 and the rotational angle positioning device 4. The drilling unit 2 is arranged with a main working direction perpendicular to the longitudinal extension of the profile sealing strand 1 and has a pneumatic linear drive as a tool feed 11. However, electric or electromechanical linear drives can also be provided as the tool feed 11. Additionally, a suction device 10 is provided.

The drilling jig 7 according to the invention for a profile sealing strand 1 (not shown) according to FIG. 2 shows a drilling unit 2 and two guiding devices 3, which are arranged before and after the rotational angle positioning device 4 in the conveying direction 14 of the profile sealing strand 1 and are connected to the rotational angle positioning device 4. The guiding devices 3 each comprise at least one guiding unit 5. The drilling unit 2 is arranged between the guiding unit 5 of the guiding devices 3, which is arranged before the rotational angle positioning device 4 in the conveying direction 14 of the profile sealing strand 1, and the rotational angle positioning device 4. By the guiding device 3 with the at least one guiding unit 5, the profile sealing strand 1 (not shown) can be guided in its longitudinal extension. As already described, the profile sealing strand 1 can be rotated relative to the drilling unit 2 around the longitudinal axis of the profile sealing strand 1 by or through the guiding devices 3 and their at least one guiding unit 5, in order to produce the hole according to the position requirements.

The guiding unit 5 has a 45 degree inclined roller guide as a contour guide.

The rotational angle positioning device 4 is driven, as described above, by a worm gear drive with a worm 8 and a worm wheel 9.

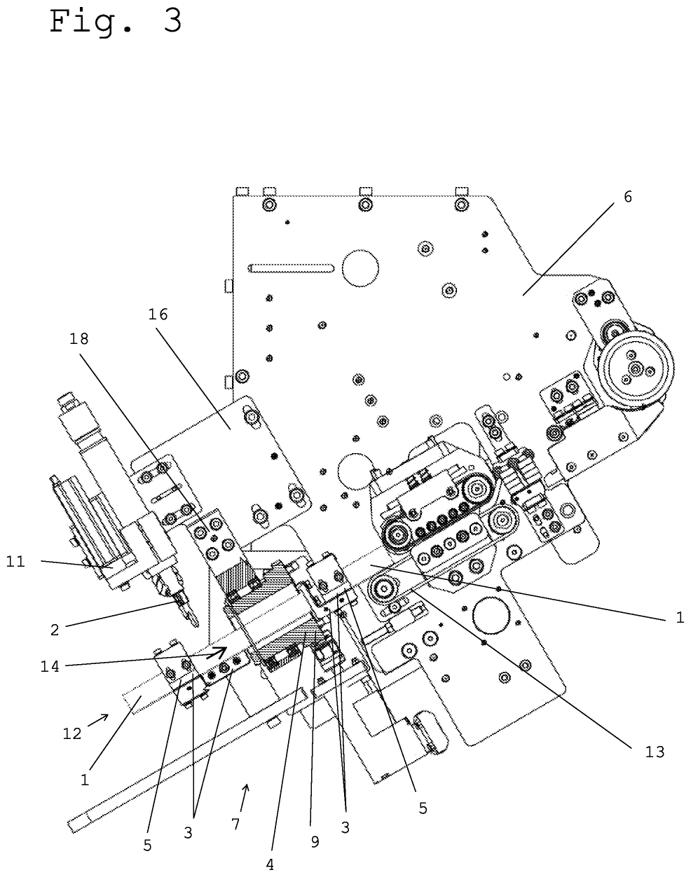

The drilling unit 2 is arranged with a main working direction perpendicular to the longitudinal extension of the profile sealing strand 1 and has a pneumatic linear drive as a tool feed 11. In this example as well, a suction device 10 is provided. FIG. 3 shows a known application head 6 of a profile sealing strand application device, which, according to the invention, includes a drilling jig 7 as shown in FIGS. 1 and 2. The drilling jig 7 is arranged in the area of the feed 12 of a profile sealing strand 1 and before a length measurement 13 of the profile sealing strand 1. The drilling unit 2 is arranged between the guiding unit 5 of the guiding devices 3, which is arranged before the rotational angle positioning device 4 in the conveying direction 14 of the profile sealing strand 1, and the rotational angle positioning device 4. Reference is made to the description of FIGS. 1 and 2.

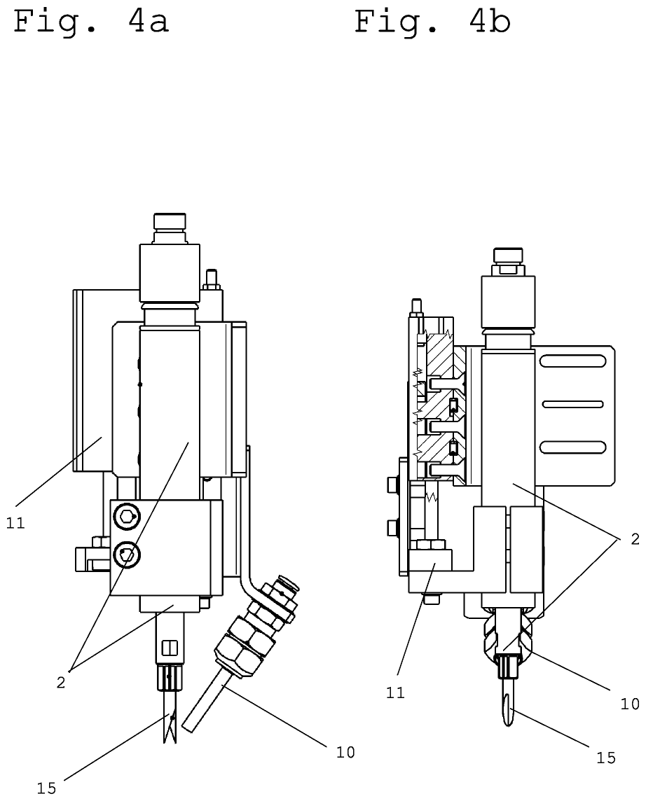

FIGS. 4a and 4b each show a drilling unit 2, which has an electronic drive for the drill 15 and, as described above, a pneumatic linear drive as a tool feed 11, connected to the drilling jig 7.

Other drives, as described above, are also conceivable.

The feed speed for the tool feed 11 depends on the moving masses and the sensitivity of the profile sealing strand 1. For example, a hole meeting the requirements can be produced with a feed speed for the tool feed 11 of v=0.075 m/s. However, higher feed speeds can also be provided.

Furthermore, the suction device 10 is arranged on the drilling unit 2. The suction device 10 is guided to the drill 15. For simplicity, the peripheral suction hose leading away from the suction device 10 is not shown.

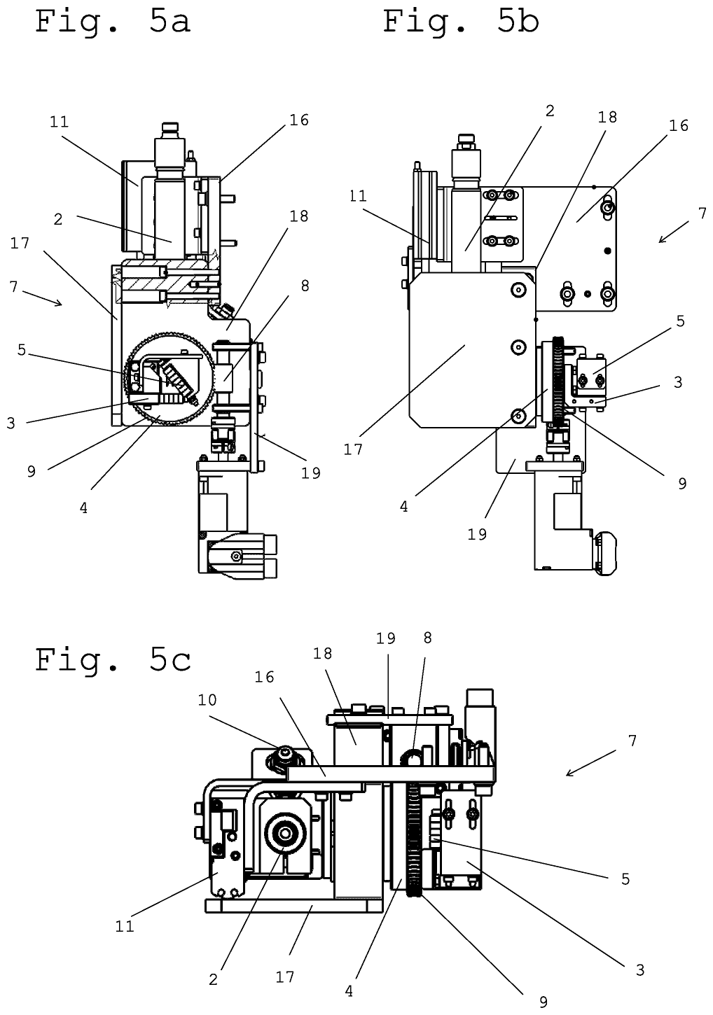

FIGS. 5a to 5c show the drilling jig 7 according to the invention for a profile sealing strand 1 (not shown). On a base plate 16, the drilling unit 2 with the tool feed 11 and a guiding block 18 are arranged. On or in the guiding block 18, as shown in FIGS. 5a to 5c and 7, the rotational angle positioning device 4 is rotatably mounted, and the guiding device 3 with the respective guiding units 5 is arranged on the rotational angle positioning device 4. As described above, the rotational angle positioning device 4 is driven by a worm wheel 9 and a worm 8.

With the guiding block 18, a covering protective wall 17 is present and arranged in front of and covering the drill 15. Since a system comprising the profile sealing strand application device is inherently enclosed in a cell and cannot be entered during operation, injury protection only needs to be ensured during standstill. Thus, only the drill 15 needs to be shielded to prevent injury from cutting on it. The drilling chips are disposed of via a suction device 10.

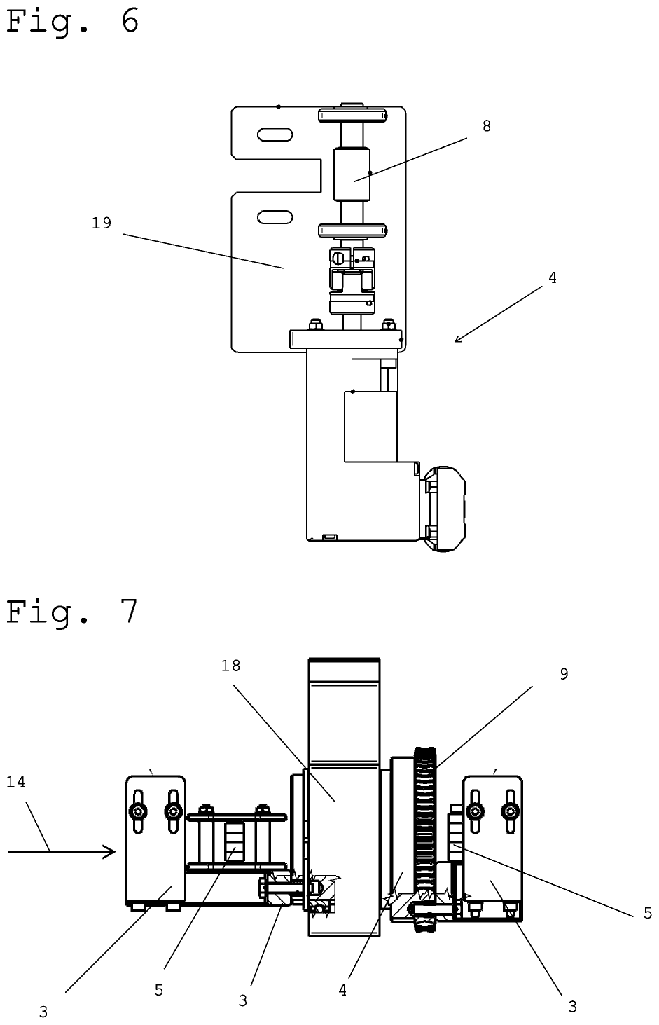

On the guiding block 18, the worm 8 of the rotational angle positioning device 4, which is simplified in FIG. 6, is also arranged via a mounting plate 19.

FIG. 7 shows the guiding block 18 and the worm wheel 9 of the rotational angle positioning device 4, which is rotatably mounted therein. On both sides of the rotational angle positioning device 4 or the worm wheel 9, a guiding device 3 with the respective at least one guiding unit 5 is arranged. Additionally, a guiding unit 5 designed as a support guide is arranged on the guiding device 3, which is located before the rotational angle positioning device 4 in the conveying direction 14.

The system according to the invention for applying a profile sealing strand to a door or a vehicle body comprises a drilling jig 7 as described above and a profile sealing strand application device with an application head 6 for applying the profile sealing strand 1 to the door or the vehicle body. Here, the drilling jig 7 is advantageously arranged, as shown in FIG. 3, in the area of the feed 12 of the profile sealing strand 1 to the profile sealing strand application device, before a length measurement 13 of the profile sealing strand 1.

Advantageously, the drilling jig 7 is movable or displaceable along a conveying direction 14 parallel to the feed 12 of the profile sealing strand 1.

The method according to the invention for producing a hole in a profile sealing strand 1 using a drilling jig 7 involves rotating the profile sealing strand 1, which is moving or stationary in the direction or conveying direction 14 of its longitudinal extension, from an initial position around a longitudinal axis of the longitudinal extension by between 0 degrees and 75 degrees as needed into a drilling position. Subsequently, a hole is produced in the profile sealing strand 1 in the drilling position using a drilling unit 2. After producing the hole, the profile sealing strand 1 is rotated back from the drilling position to the initial position as needed. Here, when the profile sealing strand 1 is rotated around the longitudinal axis of the longitudinal extension by 0 degrees, the initial position and the drilling position are the same.

The sealing profile, as the profile sealing strand 1, is stopped in the longitudinal direction or conveying direction 14 at the required location, and then the drilling position is set as the drilling angle by rotating the rotational angle positioning device 4. Once the desired drilling position is set, the hole is drilled by moving the drilling unit 2 as a drilling tool to its stop in the direction of the profile sealing strand 1. Next, the drilling unit 2 returns to its initial position, and subsequently, the adjustment angle is reset from the drilling position to zero. Now, the profile sealing strand 1 can be further conveyed in the conveying direction 14 until the next drilling position is reached, and the process is repeated. Here, the respective drilling positions or angles of the drilling position must be achieved without collision.

Advantageously, the drilling jig 7 according to the invention or the application head 6 of a profile sealing strand application device with the drilling jig 7 can be used in systems with stationary application or mobile application on a robot with at least one arm section arranged on the robot or on another handling device.

Similarly, the system according to the invention for applying a profile sealing strand 1 with a drilling jig 7 according to the invention and a profile sealing strand application device with an application head 6 according to the invention for applying the profile sealing strand 1, as well as the method according to the invention for producing a hole in a profile sealing strand 1 using a drilling jig 7 according to the invention, can be used in stationary and mobile applications.

### LIST OF REFERENCE NUMERALS

1—Profile sealing strand
2—Drilling unit
3—Guiding device
4—Rotational angle positioning device
5—Guiding unit
6—Application head
7—Drilling jig
8—Worm
9—Worm wheel
10—Suction device
11—Tool feed
12—Feed
13—Length measurement
14—Conveying direction
15—Drill
16—Base plate
17—Protective wall
18—Guiding block
19—Mounting plate

1. Drilling jig (7) for a profile sealing strand (1),
characterized in
that a drilling unit (2) is provided and that at least one guiding device (3) is provided, through which the profile sealing strand (1) can be guided in a longitudinal extension, wherein the guiding device (3) is rotatable with the profile sealing strand (1) relative to the drilling unit (2) around a longitudinal axis of the longitudinal extension of the profile sealing strand (1), and that the guiding device (3) comprises a rotational angle positioning device (4).

2. Drilling jig (7) according to claim 1,
characterized in
that the guiding device (3) comprises at least one guiding unit (5), wherein, in the case of two or more guiding units (5), the guiding units (5) are arranged at a distance from each other.

3. Drilling jig (7) according to claim 2,
characterized in
that the rotational angle positioning device (4) is arranged in the area of the at least one guiding unit (5) or, in the case of two or more guiding units (5), between two of the guiding units (5) or outside or away from the guiding units (5).

4. Drilling jig (7) according to claim 2,
characterized in
that the rotational angle positioning device (4) comprises a guiding unit (5).

5. Drilling jig (7) according to claim 2,
characterized in
that the guiding unit (5) comprises a roller guide, a contour guide, or a support guide.

6. Drilling jig (7) according to claim 1,
characterized in
that the rotational angle positioning device (4) comprises friction wheels, a crank mechanism, a worm gear drive, or a gear drive.

7. Drilling jig (7) according to claim 1,
characterized in
that the rotational angle positioning device (4) is drivable by means of a pneumatic cylinder, a worm gear as a linear drive, or a worm gear drive with a worm (8) and a worm wheel (9), or a stepper motor, or a servomotor, or a combination of at least two of the mentioned drives.

8. Drilling jig (7) according to claim 1,
characterized in
that the drilling unit (2) is arranged in the area of the guiding device (3) or in the area of the at least one guiding unit (5) or, in the case of two or more guiding units (5), between two of the guiding units (5) or in the area of the rotational angle positioning device (4).

9. Drilling jig (7) according to claim 1,
characterized in
that the drilling unit (2) is arranged with a main working direction transverse or perpendicular to the longitudinal extension of the profile sealing strand (1).

10. Drilling jig (7) according to claim 1,
characterized in
that the drilling unit (2) comprises a pneumatic, electric, or electromechanical linear drive as a tool feed (11).

11. Drilling jig (7) according to claim 1,
characterized in
that a suction device (10), a blower, or a collection tray is provided.

12. Application head (6) of a profile sealing strand application device,
characterized in
that the application head (6) comprises a drilling jig (7) according to one of the claim 1.

13. Application head (6) according to claim 12,
characterized in
that the drilling jig (7) is arranged in the area of the feed (12) of a profile sealing strand (1) and/or before or after a length measurement (13) of the profile sealing strand (1).

14. System for applying a profile sealing strand to a door or a vehicle body,
characterized in
that the system comprises a drilling jig (7) according to claim 1 and a profile sealing strand application device with an application head (6) for applying the profile sealing strand (1) to the door or the vehicle body.

15. System according to claim 14,
characterized in
that the drilling jig (7) is arranged in the area of the feed (12) of the profile sealing strand (1) to the profile sealing strand application device and/or before or after a length measurement (13) of the profile sealing strand (1).

16. Application head (6) according to claim 12,
characterized in
that the drilling jig (7) is movable or displaceable along a conveying direction (14) parallel to the feed (12) of the profile sealing strand (1).

17. Method for producing a hole in a profile sealing strand (1) using a drilling jig (7) according to claim 1,
characterized in
that the profile sealing strand (1), which is moving or stationary in the direction of its longitudinal extension, is rotated from an initial position around a longitudinal axis of the longitudinal extension by between 0 degrees and 75 degrees as needed into a drilling position, and that subsequently, in the drilling position, a drilling unit (2) produces a hole in the profile sealing strand (1), after which the profile sealing strand (1) is rotated back from the drilling position to the initial position as needed, wherein, when the profile sealing strand (1) is rotated around the longitudinal axis of the longitudinal extension by 0 degrees, the initial position and the drilling position are the same.

18. System according to claim 14,
characterized in
that the drilling jig (7) is movable or displaceable along a conveying direction (14) parallel to the feed (12) of the profile sealing strand (1).
